(19) United States
(12) Patent Application Publication
(10) Pub. No.: US 2009/0280295 A1
(43) Pub. Date: Nov. 12, 2009

(54) FLEXIBLE MAT AND MODULAR MAT SYSTEM

(76) Inventors: Melissa A. Prince, Salt Lake City, UT (US); Alan B. Andrelczyk, Draper, UT (US)

Correspondence Address: HOLLAND & HART LLP, 60 E. South Temple, Suite 2000, P.O. Box 11583, Salt Lake City, UT, 84110, US

(21) Appl. No.: 12/116,055

(22) Filed: May 6, 2008

(51) Int. Cl. B32B 3/10

(52) U.S. Cl. 428/139; 428/131

(57) ABSTRACT

A flexible mat may comprise at least one first component, at least one second component pivotably attached to the first component, and at least one substantially vertically oriented aperture defined through at least one of the first component and the second component. The second component may be pivotably attached to a side of the first component. In addition, at least one additional component may be removably attached to an end of at least one of the first component and the second component. A corresponding method for assembling a flexible mat is also disclosed.

### BACKGROUND

Over the years, flexible mats have been used for a variety of applications. For example, a mat formed of plastic, cotton, or some other material may be placed beneath the floor of a tent while camping to insulate the tent from the ground. Rubberized mats are also commonly used as floor liners in messy or damp situations, such as restaurants and food processing warehouses. Unfortunately, conventional mats may not be easily transportable, flexible, or configured to allow water or other fluids to pass or permeate through the mat. The size and shape of conventional mats are also typically fixed, limiting their potential application and usefulness.

### SUMMARY

As will be described in greater detail below, the instant disclosure generally relates to flexible mats and modular mat systems. For example, a flexible mat may comprise a plurality of components pivotably attached to one another. In certain examples, one or more substantially vertical apertures may be defined through one or more of the components used to form the mat.

The size (i.e., width or length) of a mat may be increased by attaching additional components to the sides or ends of the components used to form the flexible mat. In addition, a connecting structure may be used to connect a first mat to a second mat to form a modular mat system.

In certain embodiments, the pivotal connection of each component used to form a flexible mat may enable the flexible mat to be rolled up for convenient storage or transport. In an additional embodiment, a hinge member may be disposed between and pivotably attached to a pair of components used to form a flexible mat to enable the components of the flexible mat to be stacked or disposed on top of one another for convenient storage or transport.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a perspective view of an exemplary flexible mat and modular mat system according to at least one embodiment.

FIG. 2 is a side view of the exemplary flexible mat illustrated in FIG. 1.

FIG. 3 is an exploded top view of the exemplary flexible mat illustrated in FIG. 1.

FIG. 4 is a perspective view of an exemplary flexible mat and modular mat system according to an additional embodiment.

FIG. 5 is a side view of the exemplary flexible mat illustrated in FIG. 4.

FIG. 6 is an exploded top view of the exemplary flexible mat illustrated in FIG. 4.

FIG. 7 is a perspective view of a component used to form an exemplary flexible mat and modular mat system according to at least one embodiment.

FIG. 8 is a top view of the component illustrated in FIG. 7.

FIG. 9 is a perspective view of an additional component used to form an exemplary flexible mat and modular mat system according to at least one embodiment.

FIG. 10 is a top view of the component illustrated in FIG. 9.

FIG. 11 is a perspective view of an exemplary modular mat system according to at least one embodiment.

FIG. 12 is an exploded perspective view of the exemplary modular mat system illustrated in FIG. 11.

FIG. 13 is an additional perspective view of the exemplary modular mat system illustrated in FIG. 11.

FIG. 14 is a sectional view of a portion of the exemplary modular mat system illustrated in FIG. 13, taken along line 14-14.

FIG. 15 is a perspective view of an exemplary connecting structure for connecting components of a modular mat system according to at least one embodiment.

FIG. 16 is a side view of the exemplary connecting structure illustrated in FIG. 15.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

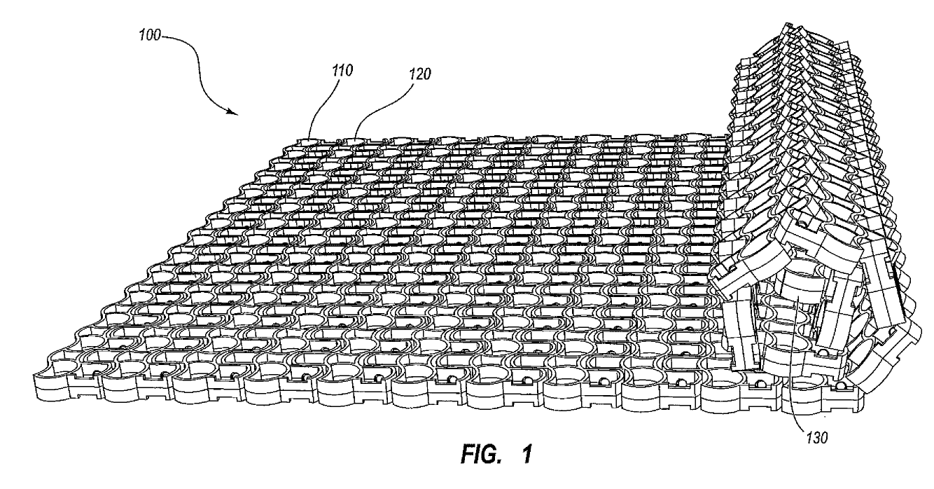

As will be described in greater detail below, the instant disclosure generally relates to a flexible mat and a modular mat system. FIGS. 1-3 are perspective, side, and exploded top views, respectively, of an exemplary flexible mat 100 according to at least one embodiment. As illustrated in these figures, exemplary mat 100 may comprise a plurality of components 120. In at least one embodiment, each component 120 of exemplary mat 100 may be pivotably attached to at least one additional component 120.

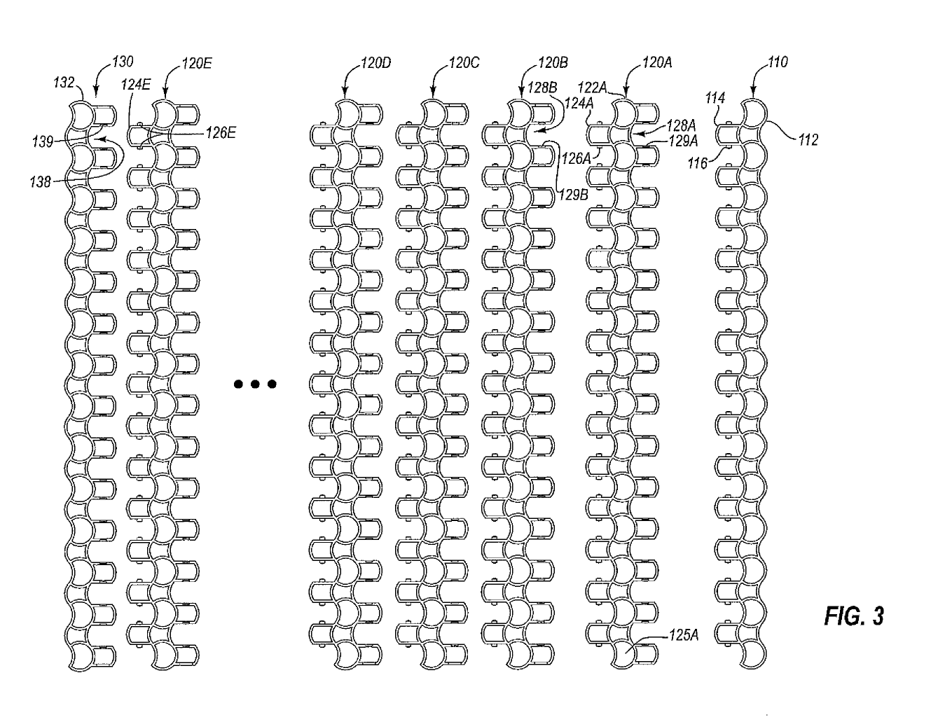

Components 120 may be pivotably attached to one another in a variety of ways. For example, as illustrated in FIG. 3, a first component 120A may be pivotably attached to a second component 120B by inserting a connector 124A provided on first component 120A into a recess 128B defined in second component 120B. In certain embodiments, a male coupling structure 126A provided on connector 124A of first component 120A may, when connector 124A is inserted into recess 128B of second component 120B, engage a female coupling aperture 129B defined within recess 128B to pivotably attach first component 120A to second component 120B.

In certain embodiments, male coupling structure 126A may be configured to “snap fit” into female coupling aperture 129B when connector 124A is inserted into recess 128B. For example, female coupling aperture 129B may be defined to have a shape that generally embodies the inverse of the shape of male coupling structure 126A. Accordingly, when connector 124A is inserted into recess 128B, male coupling structure 126A may engage or snap fit into female coupling aperture 129B to pivotably attach first component 120A to second component 120B. In certain embodiments, first component 120A may be removably attached to second component 120B.

Each component 120 of mat 100 may be formed of any material or combination of materials. Examples of suitable materials that may be used to form components 120 include, without limitation, plastic, rubber, UV-resistant material, or any other suitable material. Components 120 may also be formed in any suitable shape or size. For example, as illustrated in FIG. 3, a portion 122A of first component 120A may be crescent shaped and/or comprise a generally arcuate side wall.

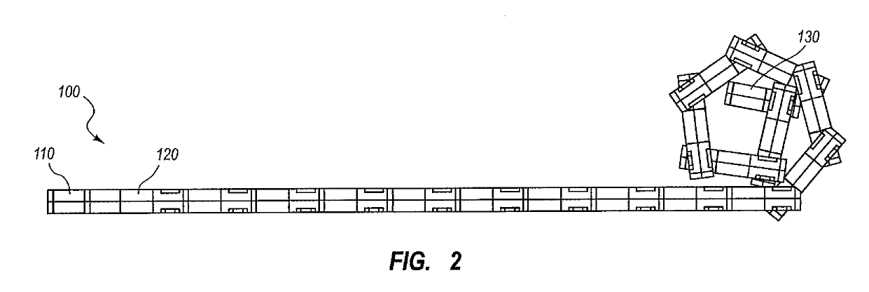

As illustrated in FIG. 2, the pivotal attachment of each component 120 used to form mat 100 may enable mat 100 to be rolled up for storage or transport. In at least one embodiment, the size and shape of exemplary mat 100 may be varied by removably attaching additional components 120 or by removing components 120 from exemplary mat 100.

In at least one embodiment, a substantially vertical aperture may be defined through one or more of components 120 used to form exemplary mat 100 in FIGS. 1-3. For example, a substantially vertically oriented aperture (such as substantially vertically oriented aperture 125A in FIG. 3) may be defined through at least a portion of first component 120A. In additional embodiments, similar apertures may be defined through additional portions of the remaining components forming exemplary mat 100. In certain embodiments, such apertures may allow water or other fluids to pass through exemplary mat 100.

In at least one embodiment, an end component may be pivotably attached to at least one component 120 used to form exemplary mat 100. For example, as illustrated in FIG. 3, a first end component 130 may be pivotably attached to component 120F by inserting a connector 124E of component 120E into a recess 138 defined in first end component 130. In certain embodiments, when connector 124E of component 120F is inserted into recess 138, a male coupling structure 126E provided on connector 124E may engage a female coupling aperture 139 defined within recess 138 to pivotably attach component 120E to first end component 130.

Similarly, a second end component 110 may be pivotably attached to first component 120A in FIG. 3 by inserting a connector 114 provided on first end component 110 into a recess 128A defined within first component 120A. In certain embodiments, when connector 114 is inserted into recess 128A, a male coupling structure 116 provided on connector 114 may engage a female coupling aperture 129A defined within recess 128A to pivotably attach second end component 110 to first component 120A.

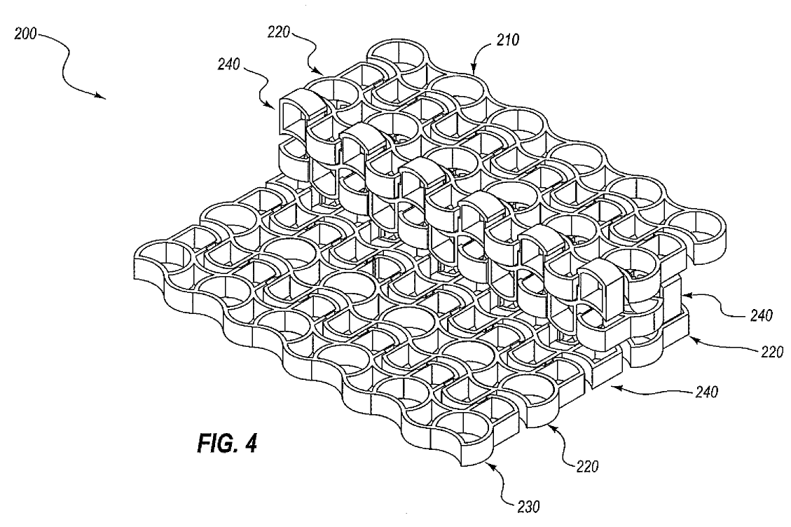

In an additional embodiment, a hinge component may be interposed between and pivotably attached to first component 120A and second component 120B in FIG. 3 to enable second component 120B to be disposed on top of first component 120A for convenient storage or transport. FIGS. 4-6 are perspective, side, and exploded top views, respectively, of an exemplary flexible mat and modular mat system in which components used to form the mat may be disposed one top of one another for convenient storage or transport. As illustrated in these figures, an exemplary mat 200 may comprise a plurality of components 220 and one or more hinge components 240.

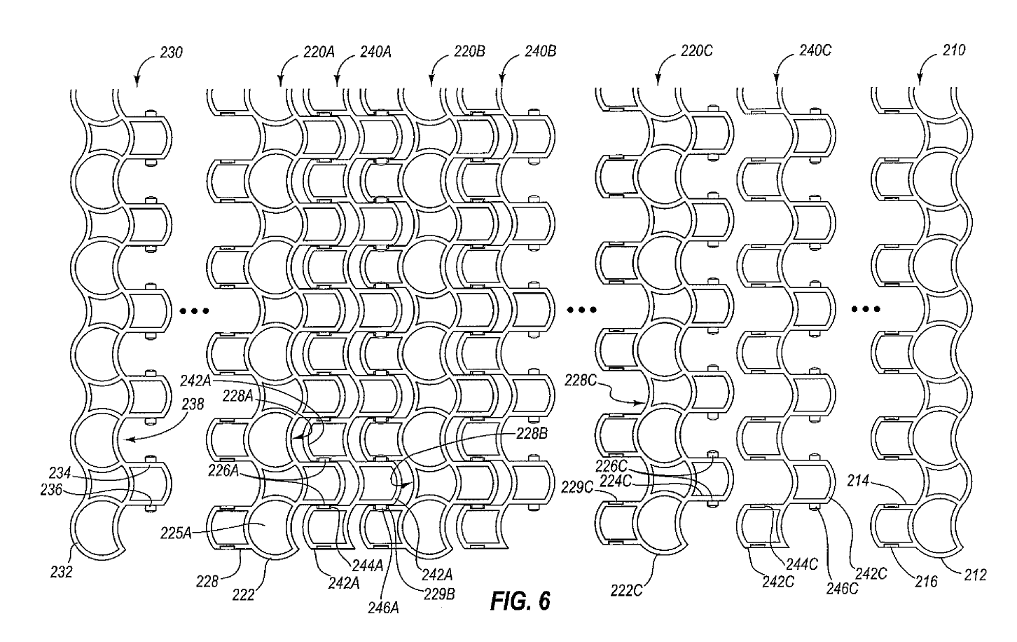

For example, as illustrated in FIG. 6, a first hinge component 240A may be pivotably attached to a first component 220A by inserting a connector 242A of first hinge component 240A into a recess 228A defined in first component 220A. In certain embodiments, when connector 242A of first hinge component 240A is inserted into recess 228A of first component 220A, a male coupling structure 226A provided within recess 228A may engage a female coupling aperture 244A defined within connector 242A to pivotably attach first component 220A to first hinge component 240A.

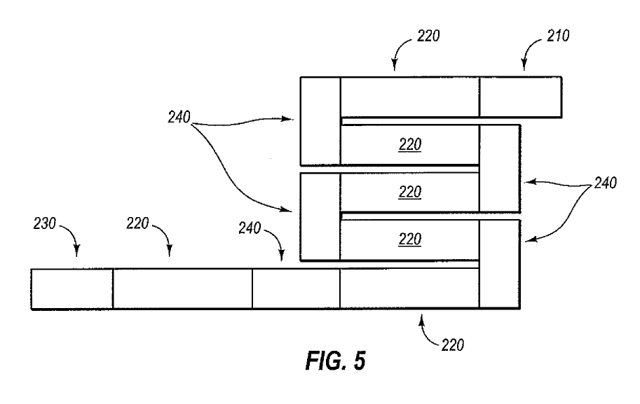

Similarly, first hinge component 240A may be pivotably attached to a second component 220B by inserting a connector 242A of first hinge component 240A into a recess 228B defined by second connector 220B. In certain embodiments, when connector 242A is inserted into recess 228B, a male coupling structure 246A provided on connector 242A may engage a female coupling aperture 229A defined within recess 228B to pivotably attach first hinge component 240A to second component 220B. As illustrated in FIGS. 4 and 5, hinge components 240 may enable one or more components 220 of exemplary mat 200 to be stacked on top of one another for convenient storage or transfer.

As with exemplary mat 100 in FIGS. 1-3, one or more end components, such as end components 210 and 230 in FIGS. 4-6, may be pivotably attached to one or more of the components of exemplary mat 200. In addition, as with exemplary mat 100 in FIGS. 1-3, one or more substantially vertically oriented apertures may be defined through one or more of the components used to form exemplary mat 200 in FIGS. 4-6. For example, a substantially vertically oriented aperture 225A may be defined through at least a portion of first component 220A. In additional embodiments, similar apertures may be defined through portions of the remaining components forming exemplary mat 200.

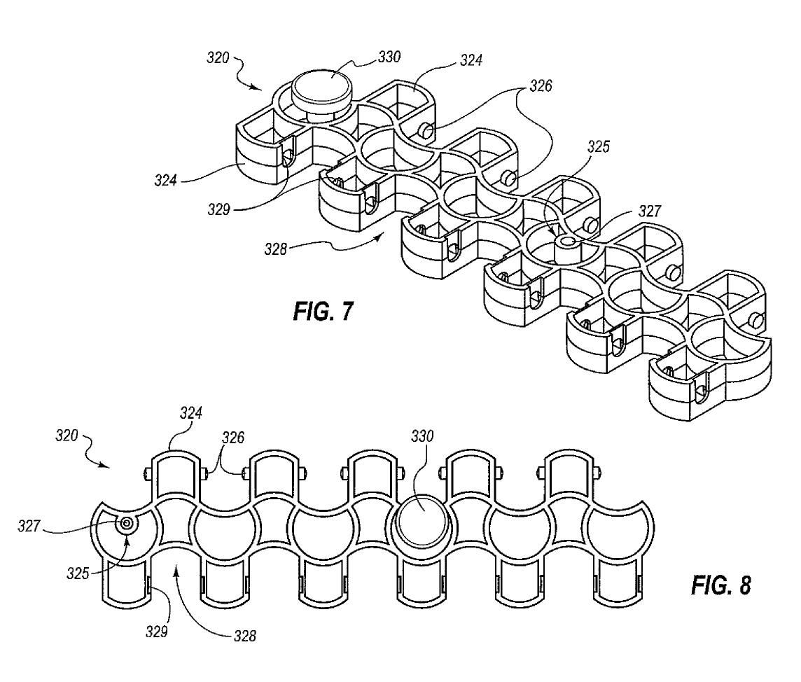

FIGS. 7 and 8 are perspective and top views, respectively, of an exemplary component 320 that may be used to form a flexible mat and/or modular mat system according to an additional embodiment. As illustrated in these figures, component 320 may comprise one or more connectors 324 and one or more recesses 328. In certain embodiments, component 320 may also comprise one or more cushion-retention structures 325. As illustrated in FIGS. 7-8, an aperture 327 may be defined within cushion-retention structure 325 and structured to receive at least a portion of a cushion or traction member, such as cushion or traction member 330. Cushion or traction member 330 generally represents any type or form of structure that may be used to dampen, cushion, or support or provide additional traction for a flexible or modular mat system. Cushion or traction member 330 may be formed of any material or combination of materials. Examples of suitable materials that may be used to form cushion or traction member 330 include, without limitation, rubber or any other resilient material.

In at least one embodiment, one or more cushion or traction members 330 may be affixed to the underside of a flexible mat, such as flexible mats 100 and 200 in FIGS. 1-6, by inserting at least a portion of cushion or traction member 330 into aperture 327 defined in cushion-retention structure 325 of component 320. In certain embodiments, cushion or traction member 330 may be formed of a material capable of increasing traction between a mat (such as mats 100 and 200 in FIGS. 1-6) and the floor or ground beneath the mat. For example, cushion or traction member 330 may be formed of rubber to prevent mats 100 and 200 from slipping or sliding relative to a wet floor or surface beneath mats 100 and 200.

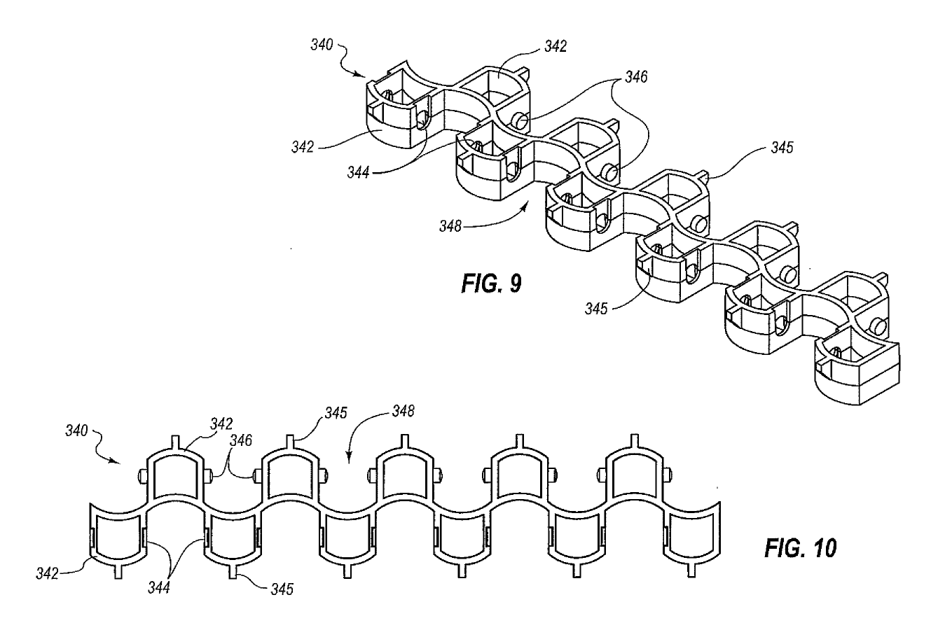

FIGS. 9 and 10 are perspective and top views, respectively, of an exemplary hinge component 340 according to an additional embodiment. As illustrated in these figures, hinge component 340 may comprise one or more connectors 342 and one or more recesses 348. In certain embodiments, one or more biasing members 345 may be provided on one or more of connectors 342. In certain embodiments, biasing members 345 may prevent movement of hinge component 340 relative to an additional component of a mat, such as components 120 and 220 in FIGS. 1-6. For example, a biasing member 345 provided on connector 342 of hinge component 340 may only allow a user of exemplary mat 200 in FIGS. 4-6 to pivot hinge component 340 relative to an adjacent component (such as first component 220A adjacent first hinge component 240A in FIG. 6) in a single (or first) direction. In this example, if a user attempts to pivot hinge member 340 in a second direction that is opposite to the first direction, biasing member 345 may contact a side wall of the adjacent component to prevent hinge member 340 from pivoting in the second direction. In certain embodiments, biasing member 345 may prevent a user from folding a mat in a less-than-optimal manner.

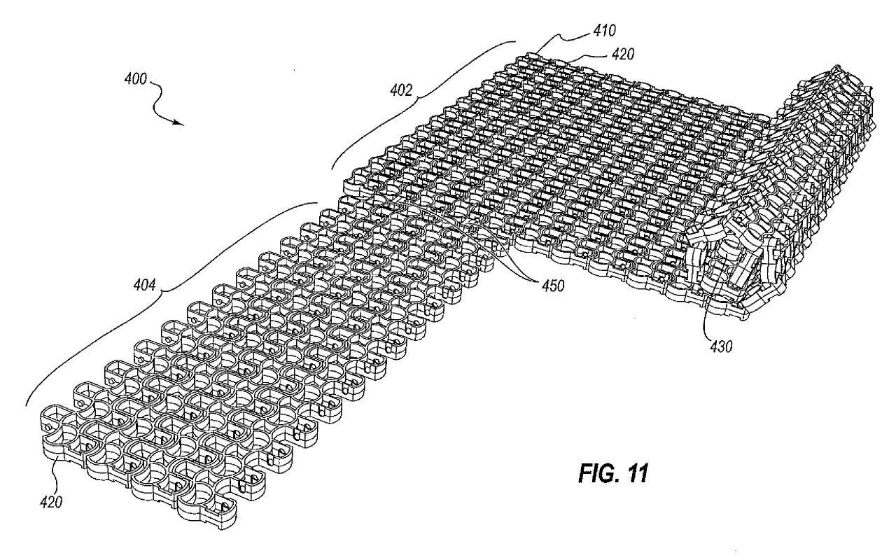

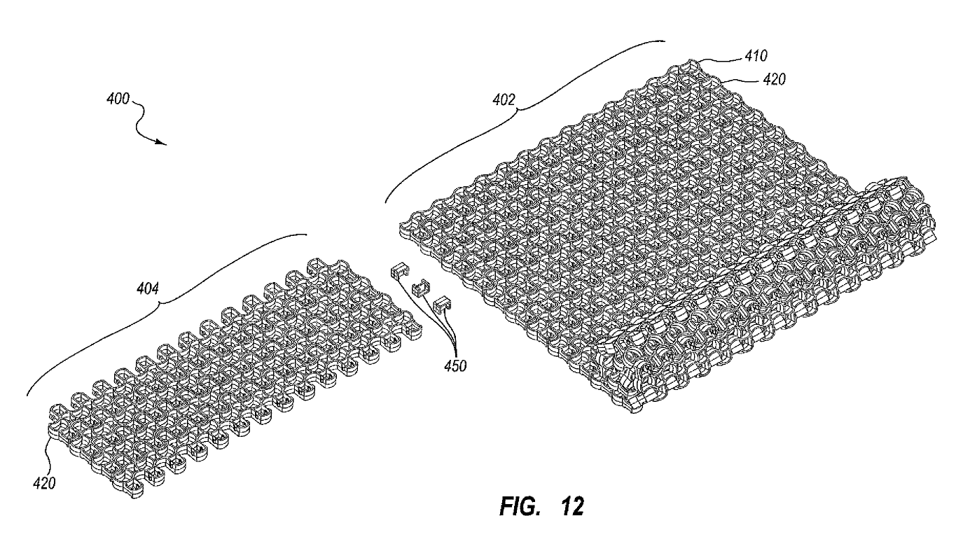

As detailed above, a flexible mat according to the instant disclosure may be formed in a variety of shapes and sized by removably attaching or removing one or more components. In certain embodiments, the size of a mat may be increased by attaching one or more components to the ends of an existing mat structure. FIGS. 11-14 are perspective views of an exemplary modular mat system 400 in which additional components may be attached to the ends of an existing flexible mat. As illustrated in these figures, modular mat system 400 may comprise a first mat 402 and a second mat 404. As detailed above, first mat 402 and second mat 404 may comprise a plurality of pivotably attached components 420. First mat 402 and/or second mat 404 may also comprise one or more end components, such as first end component 410 and second end component 430.

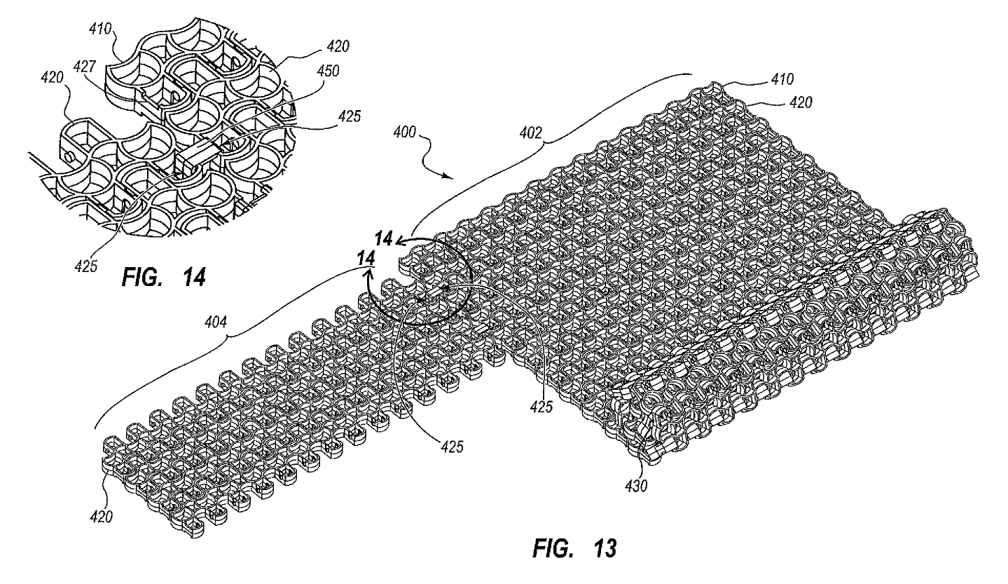

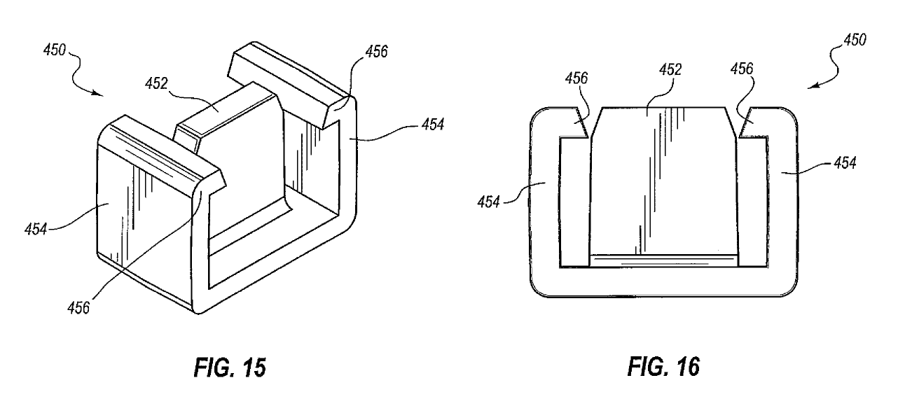

In certain embodiments, first mat 402 may be removably attached to second mat 404 using one or more connecting structures 450. FIGS. 15 and 16 are perspective and side views, respectively, of an exemplary connecting structure 450. In certain embodiments, first mat 402 may be removably attached to second mat 404 by inserting legs 454 of connecting structure 450 into substantially vertical apertures 425 defined in components 420, as illustrated in FIGS. 13 and 14. When legs 454 of connecting structure 450 are inserted into apertures 425 of components 420, a hook structure 456 provided on the ends of legs 454 of connecting structure 450 may engage a notch 427 defined in component 420 to securely attach connecting structure 450 to component 420.

In certain embodiments, connecting structure 450 may enable the creation of a mat in any shape or size. Moreover, as detailed above, the size of the mat may be modified by varying the shape and size of each individual component used to form the mat. In certain embodiments, each component used to form a mat may be 22 inches in length and 14 inches in width. In an alternative embodiment, each component used to form a mat may be 22 inches in length and 34.75 inches in width.

The exemplary mat and modular mat systems described and/or illustrated herein may be utilized in a variety of ways. For example, these mats and mat systems may be used as a vestibule mat for a tent. Many conventional tents come with an optional fly that may cover all or a portion of the tent to protect the tent from weather. Some tent flies extend out over the tent door, providing a sort of porch roof and storage area. This semi-protected area is commonly referred to as the “vestibule.” In addition to representing a convenient location for storing footwear and other gear, the vestibule area of a tent may provides campers with some protection from the weather while entering and exiting the tent. When used as a vestibule mat for a tent, the mats and mat systems disclosed herein may provide an area for users to wipe off footwear before entering the tent and a cleaner area for users to stand or place footwear when exiting the tent. These mats and mat systems may also suspend users and their footwear and/or camping gear from the ground underneath, which may be sandy or muddy.

The mats and mat systems disclosed herein may also be used as a tent ground cloth by placing the mat or mat system beneath a tent. The mat may elevate the tent from the ground and any moisture underneath. The mats and mat systems disclosed herein may also be used as a portable camping shower mat to prevent a user's feet from touching the ground or floor of a public shower while showering. These mats may also be used as a locker liner to elevate a user's items from the floor of a public locker.

The mats disclosed herein may also be used to suspend items off of the floor of a boat or aquatic apparatus to prevent water splashed into the boat or apparatus from damaging items suspended by the mat. The mats disclosed herein may also be used when grooming or washing animals, as liners for animal kennels or portable carriers, as a liner or suspended floor for animal cages (such as rabbit and chicken cages), and/or as a shelf liner for green houses. The mats disclosed herein may also be used as a liner for storage sheds to keep boxes off of the ground or floor, as floor mats for messy or damp situations (such as food processing warehouses, fish markets, and the like), as a floor or shelf mat in restaurants, as a floor mat in walk-in freezers, as a submersible mat for underwater operations, and as a cargo-bay liner for airplanes.

The mats disclosed herein may also be used as a shelf liner or cooling mat for electronics, computers, or other equipment that require air flow and heat dissipation. In addition, the mats disclosed herein may be used as a door mat, as a non-conductive mat for working in areas where electrical shock is possible, and as an anti-fatigue mat. These mats may also be used as a trivet for hot pans, warming trays, pots, or the like.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.”

What is claimed is:

1. A flexible mat, comprising:
a mat structure, the mat structure comprising:
at least one first component;
at least one second component pivotably attached to the first component;
at least one substantially vertical aperture defined through at least one of the first component and the second component.

2. The flexible mat of claim 1, further comprising an end component pivotably attached to an end of at least one of the first component and the second component.

3. The flexible mat of claim 1, further comprising:
at least one recess defined in the first component;
at least one connector provided on the second component, the connector of the second component being insertable into the recess in the first component to pivotably attach the second component to the first component.

4. The flexible mat of claim 3, further comprising:
a female coupling aperture defined within the recess in the first component;
a male coupling structure provided on the connector of the second component;
wherein, when the connector of the second component is inserted into the recess in the first component, the male coupling structure engages the female coupling aperture to pivotably attach the second component to the first component.

5. The flexible mat of claim 4, wherein, when the connector of the second component is inserted into the recess in the first component, the male coupling structure engages the female coupling aperture to create a snap-fit connection.

6. The flexible mat of claim 3, further comprising:
a male coupling structure provided within the recess defined in the first component;
a female coupling aperture defined within the connector of the second component;
wherein, when the connector of the second component is inserted into the recess in the first component, the male coupling structure engages the female coupling aperture to pivotably attach the second component to the first component.

7. The flexible mat of claim 1, wherein the second component is removably attached to the first component.

8. The flexible mat of claim 1, wherein at least one of the first component and the second component comprises at least one arcuate side wall.

9. The flexible mat of claim 1, wherein at least a portion of at least one of the first component and the second component is crescent shaped.

10. The flexible mat of claim 1, further comprising a cushion or traction member attached to a bottom surface of at least one of the first component and the second component.

11. The flexible mat of claim 10, wherein the cushion or traction member is removably attached to at least one of the first component and the second component.

12. The flexible mat of claim 10, wherein the cushion or traction member is formed of rubber.

13. The flexible mat of claim 1, further comprising a hinge component interposed between the first component and the second component, wherein the hinge component is pivotably attached to both the first component and the second component to enable the second component to be disposed on top of the first component.

14. The flexible mat of claim 13, wherein the hinge component comprises at least one biasing member that prevents movement of the hinge component in a first direction relative to at least one of the first component and the second component.

15. The flexible mat of claim 1, wherein the second component is pivotably attached to a side of the first component.

16. The flexible mat of claim 1, further comprising at least one additional component removably attached to an end of at least one of the first component and the second component.

17. The flexible mat of claim 1, further comprising:
at least one additional component;
at least one connecting structure that removably attaches the additional component to an end of at least one of the first component and the second component.

18. The flexible mat of claim 1, wherein at least one of the first component and the second component is formed of plastic.

19. A method for assembling a flexible mat, comprising:
providing at least one first component of a mat structure having a substantially vertical aperture;
providing at least one second component of the mat structure having a substantially vertical aperture;
pivotably attaching the second component to the first component.

20. A modular, flexible mat, comprising:
a mat structure, the mat structure comprising:
at least one first component;
at least one recess defined in the first component;
at least one female coupling aperture defined within the recess in the first component;
at least one second component;
at least one connector provided on the second component;
at least one male coupling structure provided on the connector of the second component;
wherein, when the connector of the second component is inserted into the recess in the first component, the male coupling structure engages the female coupling aperture to pivotably attach the second component to the first component.
